(19) United States
(12) Patent Application Publication
(10) Pub. No.: US 2016/0124460 A1
(43) Pub. Date: May 5, 2016

(54) DISPLAY DEVICE, DISPLAY UNIT, AND CONFERENCE SYSTEM

(71) Applicant: PANASONIC INTELLECTUAL PROPERTY MANAGEMENT CO., LTD., Osaka-shi, Osaka (JP)

(72) Inventors: KEISHIRO MURATA, Kyoto (JP); TERUO DOI, Mie (JP)

(73) Assignee: Panasonic Intellectual Property Management Co., Ltd., Osaka (JP)

(21) Appl. No.: 14/890,516

(22) PCT Filed: May 27, 2014
(86) PCT No.: PCT/JP2014/002777

§ 371 Date: Nov. 11, 2015

(30) Foreign Application Priority Data
Jun. 3, 2013 (JP) 2013-116808

(51) Int. Cl. G06F 1/16; G06F 3/01; H04N 7/15; G06F 3/045; G06F 3/041; G06F 3/044; G06F 3/16

(52) U.S. Cl. CPC G06F 1/1605; G06F 3/044; G06F 3/016; G06F 3/16; G06F 3/045; G06F 3/0412; H04N 7/15; G06F 2203/04803

(57) ABSTRACT

A display device includes a touch panel having an operation surface, an electrostatic speaker provided on an opposite side of the operation surface of the touch panel, and a display panel provided on an opposite side of the electrostatic speaker with respect to the touch panel. The electrostatic speaker has a first conductive layer, a second conductive layer facing the first conductive layer, and a dielectric interposed between the first conductive layer and the second conductive layer.

### TECHNICAL FIELD

The present technical field relates to a display device used for various electronic devices, a display unit including the display device, and a conference system using the display unit.

### BACKGROUND ART

A display device is provided with functions of emitting a voice and giving a sense of touch to an operator as its size increases, and has been used for a conference system terminal, for example.

The display device has a touch panel capable of vibrating. When vibrating, the touch panel makes a voice sound or gives a sense of tough to operator's fingers (for example, PLT 1).

### CITATION LIST

### Patent Literature

PLT 1: Unexamined Japanese Patent Publication No. 2013-8118

### SUMMARY OF THE INVENTION

The display device according to the present disclosure includes a touch panel having an operation surface, an electrostatic speaker provided on an opposite side of the operation surface of the touch panel, and a display panel provided on an opposite side of the electrostatic speaker with respect to the touch panel. The electrostatic speaker has a first conductive layer, a second conductive layer facing the first conductive layer, and a dielectric interposed between the first conductive layer and the second conductive layer.

With this configuration, the display device can emit a voice from the touch panel, thereby producing a lively voice corresponding to an image.

### BRIEF DESCRIPTION OF DRAWINGS

FIG. 1 is a conceptual diagram of a conference system including a display unit according to an embodiment.

FIG. 2 is a conceptual diagram showing the display unit illustrated in FIG. 1.

FIG. 3 is a view showing a configuration of the display device illustrated in FIG. 2 and a cross section of a display device used therein.

FIG. 4 is an exploded perspective view of the display device illustrated in FIG. 3.

FIG. 5 is an exploded perspective view of another display device according to the embodiment.

FIG. 6 is a structural view showing a cross section of the display device illustrated in FIG. 5.

### DETAILED DESCRIPTION OF PREFFERED EMBODIMENTS

Prior to the description of an embodiment, problems in the conventional input device will be described. This kind of input device has a vibration unit including a piezoelectric element, and a touch panel to be vibrated by the vibration unit fixed thereto. The touch panel is vibrated to make a voice sound or give a sense of touch to operator's fingers. In the input device, output power of the vibration unit is so small that the vibration unit can vibrate only a very limited part of the touch panel. As a result, the input device may produce a poor lively voice corresponding to an image.

Hereinafter, an embodiment will be described with reference to the drawings. Note that, to understand the configuration easily, each drawing is partially enlarged in size.

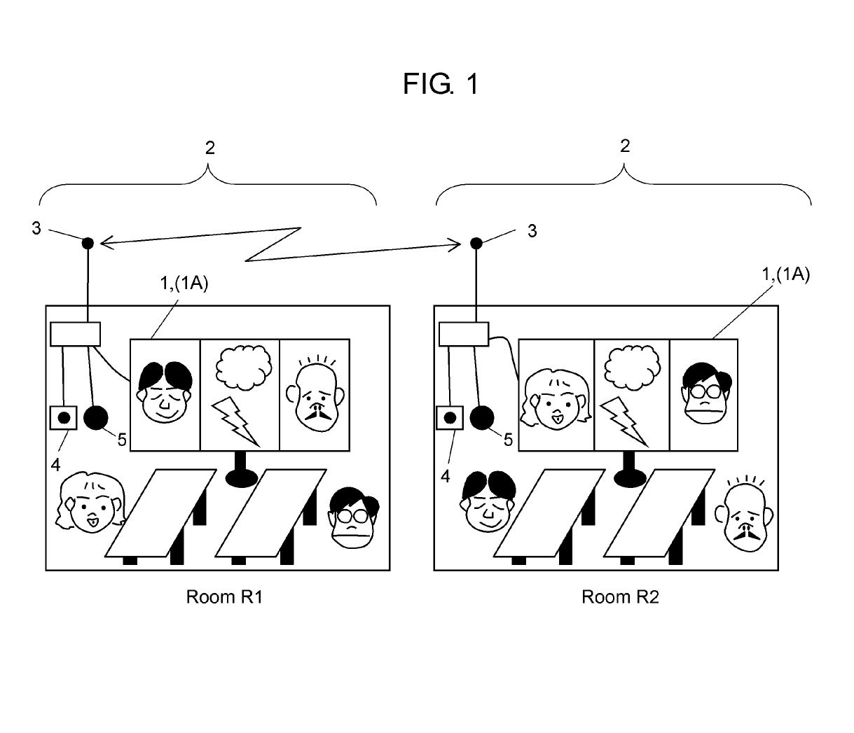

FIG. 1 is a conceptual diagram of conference system 2 using display unit 1 with display device 1A. Conference system 2 includes display unit 1 which uses display device 1A, telecommunications device 3, camera 4, and microphone 5.

Room R1 and room R2, which are located remotely from each other, are provided with conference systems 2, respectively. To transmit a voice and an image from one room to the other room, camera 4 and microphone 5 are connected to telecommunications device 3. Display unit 1 is further connected to telecommunications device 3 to receive a voice signal or to receive and transmit an image signal. In room R1, two persons attend a conference as well as in room R2. Images and voices of the attendees in room R1 are projected and reproduced by display unit 1 in room R2. Likewise, images and voices of the attendees in room R2 are also projected and reproduced by display unit 1 in room R1.

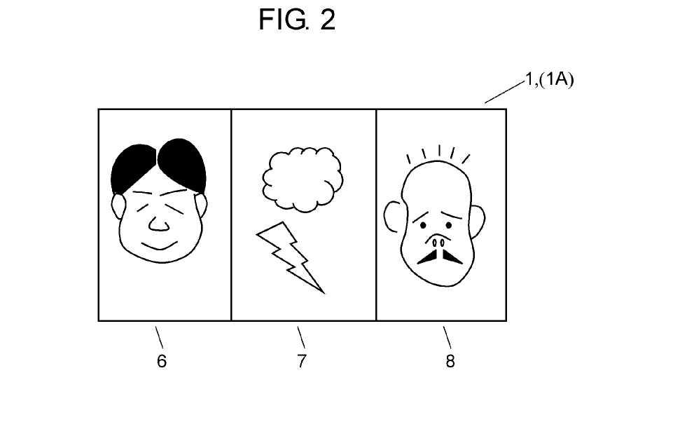

FIG. 2 is a conceptual diagram showing a display situation of display unit 1. Display unit 1 has first segment 6, second segment 7, and third segment 8. First segment 6 and third segment 8 display images while second segment 7 is operable as a touch panel. Additionally, each of first segment 6 and third segment 8 has an operable touch panel on a front surface thereof. Hereinafter, configurations and operations of display device 1A, display unit 1, and conference system 2 will be described subject to the above mentioned assumption.

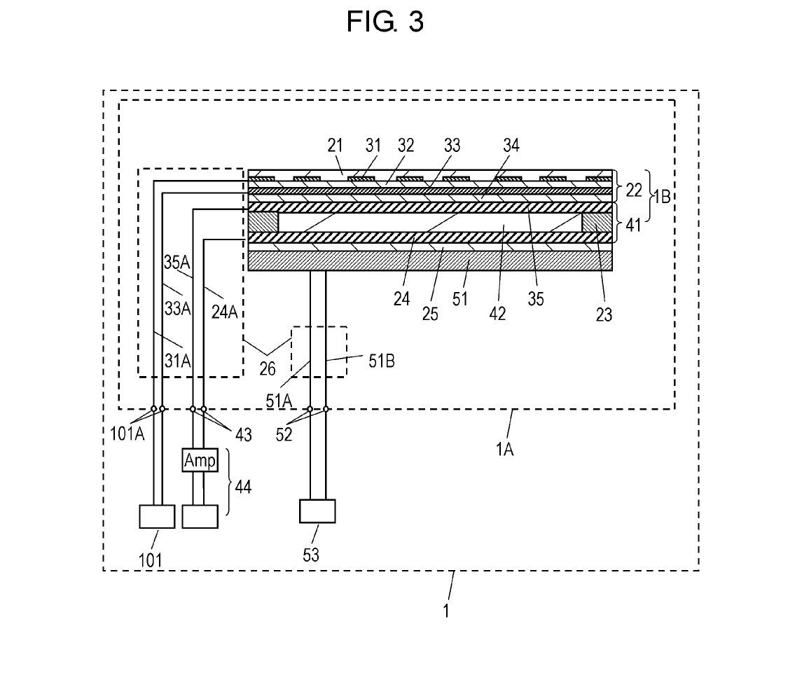

FIG. 3 is a view showing a configuration of the display device illustrated in FIG. 2 and a cross section of a display device used therein.

Display device 1A includes touch panel 22 having an operation surface, electrostatic speaker 41 provided on an opposite side of the operation surface of touch panel 22, display panel 51 provided on an opposite side of electrostatic speaker 41 with respect to touch panel 22. Electrostatic speaker 41 has first conductive layer 35, second conductive layer 24 facing first conductive layer 35, and dielectric 42 interposed between first conductive layer 35 and second conductive layer 24.

With the above configuration, touch panel 22 can vibrate according to a voice signal inputted to electrostatic speaker 41. Therefore, display device 1A can produce a lively voice corresponding to a picture and/or an image displayed on display panel 51, which are visible through touch panel 22.

Display device 1A further includes cover lens 21, vibration substrate 25 equipped with electrostatic speaker 41, display panel 51, touch panel control terminals 101A, voice signal input terminals 43, and image signal input terminals 52. Touch panel 22 is connected to touch panel controller 101 via touch panel control terminals 101A. Electrostatic speaker 41 is connected to voice signal producing device 44 via voice signal input terminals 43. Display panel 51 is connected to image signal producing device 53 via image signal input terminals 52.

Display unit 1 includes display device 1A, voice signal producing device 44 connected to electrostatic speaker 41 of display device 1A, and image signal producing device 53 connected to display panel 51.

Further, voice signal producing device 44 and image signal producing device 53 are connected to telecommunications device 3. Herein, voice signal producing device 44 and image signal producing device 53 are included in display unit 1. However, voice signal producing device 44 and image signal producing device 53 may be included in telecommunications device 3. Alternatively, one of voice signal producing device 44 and image signal producing device 53 may be included in display unit 1 and the other may be included in telecommunications device 3.

Furthermore, touch panel controller 101 may be included in display device 1A together with touch panel control terminals 101A. Alternatively, touch panel controller 101 may be connected to touch panel control terminals 101A and be provided inside display unit 1. Alternatively, touch panel controller 101 may be provided outside display unit 1.

Cover lens 21 has a substantially square shape and is formed of, for example, a sheet or a film of resin material on which a hard coat layer is formed (not shown). Alternatively, glass may be used instead of the sheet or the film of resin material.

Touch panel 22 is formed by laminating first substrate 32 and second substrate 34 in this order from the operation surface which is indicated as an upper side of the figure. First substrate 32 is provided with a plurality of first electrodes 31 thereon and second substrate 34 is provided with a plurality of second electrodes 33 thereon. Cover lens 21 is fixed to touch panel 22 via an adhesive or the like.

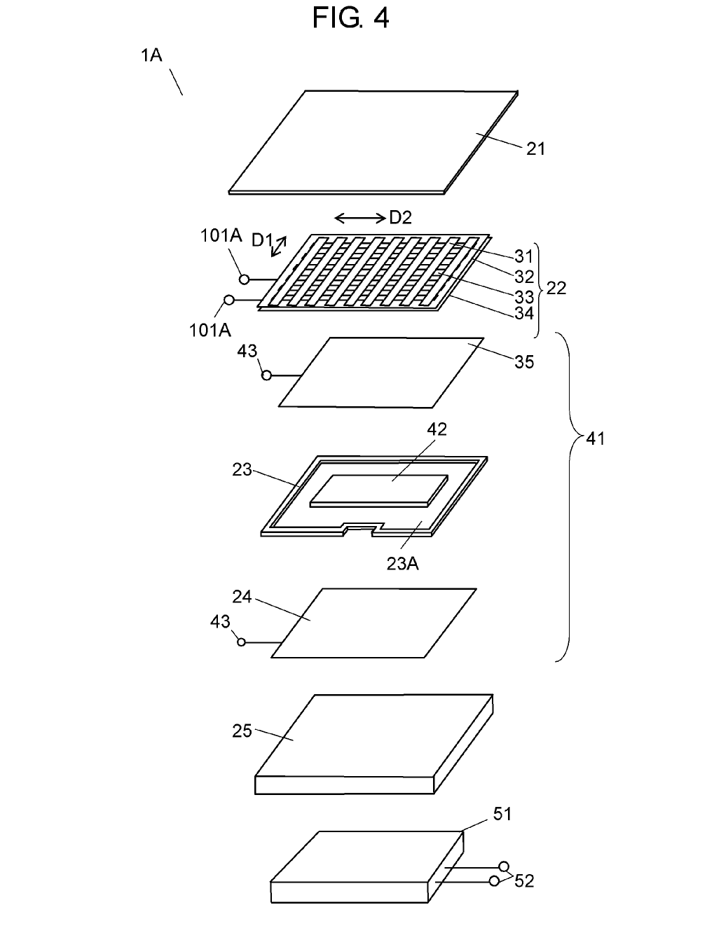

Each of first electrodes 31 has a linear or band-like shape elongating in first direction D1 of FIG. 4. First electrodes 31 are disposed parallel to each other at a predetermined interval therebetween. Note that, first electrodes 31 are preferably made of indium tin oxide, tin oxide, and a material based on these components.

First substrate 32 has a substantially square or rectangular shape, and is made of a translucent insulating resin film such as polyethylene terephthalate, polyether sulfone, and polycarbonate. Alternatively, first substrate 32 may be made of a material based on glass.

Each of second electrodes 33 has a linear or band-like shape elongating in second direction D2 of FIG. 4. Second electrodes 33 are disposed parallel to each other at a predetermined interval therebetween. Note that, second electrodes 33 are also preferably made of indium tin oxide, tin oxide, and a material based on these components. It is noted that first direction D1 and second direction D2 intersect at a predetermined angle, which is desired to be a right angle.

Second substrate 34 has a substantially square or rectangular shape, which is generally the same as that of first substrate 32. Second substrate 34 is made of, for example, a translucent insulating resin film. Alternatively, second substrate 34 may be made of a material based on glass. Note that, like cover lens 21 and touch panel 22, first substrate 32 is fixed to second substrate 34 via an adhesive or the like.

Electrostatic speaker 41 is formed of first conductive layer 35, second conductive layer 24, spacer 23 and dielectric 42 interposed therebetween.

First conductive layer 35 and second conductive layer 24 are formed of a translucent and conductive material, and each of them has a substantially square or rectangular shape, in which first conductive layer 35 and second conductive layer 24 are generally the same in shape. First conductive layer 35 and second conductive layer 24 are preferably made of indium tin oxide, tin oxide, and a material based on these components.

Alternatively, first conductive layer 35 and second conductive layer 24 may be formed of a translucent resin such as acrylic with metal such as silver or filaments such as carbon dispersed therein. Alternatively, first conductive layer 35 and second conductive layer 24 may be formed of a translucent conductive resin such as polythiophene and polyaniline.

Spacer 23 has a frame shape whose center is provided with square hole 23A. Spacer 23 is disposed so as to be interposed between first conductive layer 35 and second conductive layer 24.

Dielectric 42 is disposed within square hole 23A and interposed between first conductive layer 35 and second conductive layer 24. Dielectric 42 is made of polyethylene terephthalate, polyester, and a material based on these components, which can pass visible light. Alternatively, the air within square hole 23A may be used as dielectric 42.

Now, first conductive layer 35 and second conductive layer 24 are described as elements constituting electrostatic speaker 41. However, first conductive layer 35 may be disposed on a lower side of second substrate 34 and second conductive layer 24 may be disposed on an upper side of vibration substrate 25 in the figure. In this case, first conductive layer 35 and second conductive layer 24 are formed on second substrate 34 and vibration substrate 25, respectively, by using sputtering method, vacuum deposition method or the like.

Thus, vibration substrate 25 supports second conductive layer 24, and display device 1A can convey vibration of electrostatic speaker 41 to the outside of display device 1A. Vibration substrate 25 has a substantially square or rectangular shape and is formed of, for example, a translucent insulating film. Alternatively, vibration substrate 25 may be formed of a material based on glass.

Display panel 51 is disposed on a lower side of vibration substrate 25 in the figure. Display panel 51 and vibration substrate 25 are disposed via a dielectric such as the air or an adhesive.

Note that, second conductive layer 24 may be disposed directly on an upper side of display panel 51 in the figure, without providing vibration substrate 25. In this case, second conductive layer 24 may be formed by sputtering method, vacuum deposition method or the like. Alternatively, in the case where display panel 51 and electrostatic speaker 41 are formed separately, electrostatic speaker 41 may be placed on an upper side of display panel 51 in the figure. In this case, instead of vibration substrate 25, display panel 51 can convey vibration of electrostatic speaker 41 to the outside of display device 1A more efficiently. Further, if vibration substrate 25 is removed from between display panel 51 and electrostatic speaker 41, display panel 51 can project images more clearly on the operation surface of touch panel 22.

Further, cable 26 is constituted of a flexible printed wiring board, for example. A plurality of wirings are provided in cable 26. As shown in FIG. 3, cable 26 includes wiring 31A connected to first electrode 31, wiring 33A connected to second electrode 33, wiring 35A connected to first conductive layer 35, wiring 24A connected to second conductive layer 24, and wirings 51A, 51B connected to display panel 51.

Cable 26 may be formed as a single body, or divided into multiple pieces. Cable 26 may not be included in display device 1A.

Wirings 31A and 33A connected to first electrode 31 and second electrode 33, respectively, are connected to touch panel controller 101 via touch panel control terminals 101A. Further, wirings 35A and 24A connected to first conductive layer 35 and second conductive layer 24, respectively, are connected to voice signal producing device 44 via voice signal input terminals 43. Furthermore, wirings 51A and 51B connected to display panel 51 are connected to image signal producing device 53 via image signal input terminals 52.

Next, an operation of display unit 1 will be described. For instance, second electrode 33 is assumed to serve as a transmitting electrode, and first electrode 31 is assumed to serve as a receiving electrode. Touch panel controller 101 transmits a detection signal to one of a plurality of second electrodes 33, and receives the detection signal from one of a plurality of first electrodes 31 as a detected signal. In other words, a detection signal is transmitted from second electrode 33 to first electrode 31 via capacitance between second electrode 33 and first electrode 31, and then converted into a detected signal.

Touch panel controller 101 transmits the detection signal by switching second electrodes 33 one by one in first direction D1, for example, from an upper end to a lower end of second electrodes 33. Touch panel controller 101 receives the detected signal while transmitting the detection signal to second electrode 33. Touch panel controller 101 receives the detected signal by switching first electrodes 31 one by one in second direction D2, for example, from a left-hand side to a right-hand side of first electrodes 31.

Herein, a capacitance value between each of second electrodes 33 and each of first electrodes 31 is determined in advance. Under this condition, when a target to be detected such as a finger approaches touch panel 22, the capacitance value changes largely from its initial value.

Accordingly, the detected signal corresponding to the detection signal is also changed from its initial situation when the target to be detected such as a finger approaches touch panel 22. By measuring the time when the change occurs, a position of the target to be detected is specified in touch panel 22. In other words, touch panel controller 101 detects to which the detection signal is transmitted among second electrodes 33 and from which the detected signal is received among first electrodes 31.

In other words, touch panel controller 101 detects the position in first direction D1 by transmitting the detection signal, and the position in second direction D2 by receiving the detected signal about the point where the detected signal changes from the initial situation. By the above, touch panel controller 101 obtains position information of the target to be detected.

A rate of switching second electrodes 33 one by one to transmit the detection signal to and a rate of switching first electrodes 31 one by one to receive the detected signal from determine a detection rate of the target to be detected in touch panel 22.

Especially, a voice input signal that is inputted from voice signal producing device 44 via wirings 24A, 35A vibrates electrostatic speaker 41 to make a voice sound. Herein, electrostatic speaker 41 is constituted by first conductive layer 35, second conductive layer 24, and dielectric 42. Besides, electrostatic speaker 41 vibrates to give a sense of touch to operator's finger though cover lens 21 located on the operation surface side of touch panel 22.

The voice sound has a vibration frequency of 20 Hz or more and 20000 Hz or less. The given sense of touch has a vibration frequency of 10 Hz or more and 1000 Hz or less. Of course, the voice signal and the sense-of-touch signal may be supplied from voice signal producing device 44 simultaneously.

Especially, when electrostatic speaker 41 vibrates to make a voice sound, the vibration travels to cover lens 21 as mentioned above, and then cover lens 21 emits the voice sound. Further, entire cover lens 21 is easy to vibrate because electrostatic speaker 41 can vibrate in a large area.

As mentioned above, by using display device 1A and display unit 1, an operator or an audience can hear voice from entire touch panel 22 rather than a deviated portion of touch panel 22. Thus, display device 1A and display unit 1 can produce a voice corresponding to an image or a picture more vividly.

Further, touch panel 22 has a similar structure as electrostatic speaker 41, that is, thin-layered conductors and an insulating layer are laminated in both of them. Thus, touch panel 22 and electrostatic speaker 41 can be laminated while ensuring high adhesion. As a result, the voice sound from electrostatic speaker 41 is efficiently conveyed to touch panel 22 and cover lens 21.

In display device 1A and display unit 1 configured as mentioned above, display panel 51 is not limited to a specified display type. For instance, a liquid crystal panel, an organic electroluminescence (EL) panel, and a plasma display panel may be used for display panel 51 of display device 1A.

Display device 1A and display unit 1 may especially be used in a large-scaled display capable of selecting from displayed images while emitting a voice. In the following description, display unit 1 is used in conference systems 2 which are connected remotely with each other as shown in FIG. 1. Remotely located attendees and conference contents are projected on display device 1A used in display unit 1. Further, the conference contents are displayed as not only a projection target but also an operation target which can be operated through touch panel 22.

If the attendees, located remotely and displayed on first segment 6 shown in FIG. 1 and FIG. 2, say something, the voice is emitted from the entire surface of display device 1A. As a result, the voice and the displayed contents are matched tightly, so that the voice corresponding to the image associated with the remotely located attendees can be reproduced more vividly.

Now, weather forecast presentation is adopted as conference contents, for example. The attendees located remotely from each other can optionally touch second segment 7 with their fingers to operate it. For instance, if an attendee at one site touches second segment 7 to operate arrangement and targets of a display contents, arrangement and targets of the display contents displayed on second segment 7 of display device 1A at the other site are changed in response to the above operation. Of course, if either of the attendees at the one site emits a voice during the above touch operation, the voice is reproduced by display device 1A at the other site, and if either of the attendees at the other site emits a voice during the above touch operation, the voice is reproduced by display device 1A at the one site.

In other words, display device 1A has dual functions of displaying and touch-inputting. The dual functions are carried out simultaneously, thus, the above mentioned conference system will be more convenient.

Further, the display surface of display device 1A is divided into three segments, i.e., first segment 6, second segment 7, and third segment 8. The respective segments may be overlapped. Even if the segments are overlapped, the dual functions of displaying and touch-inputting can operate independently as mentioned above. Thus, arrangement and targets of the display contents regarding the conference object can be operated by touching.

Further, the number of segments or a display position of conference contents is not restricted.

Furthermore, electrostatic speaker 41 may be constituted by a plurality of segments, although illustrated as a single speaker. As a result, electrostatic speaker 41 can operate approximately in correspondence with the segments of touch panel 22. This makes it possible to reproduce a voice at even an intentionally deviated position. In other words, the display surface of display device 1A may be divided into a largely vibrating part and a small vibrating part. As a result, an operator can avoid receiving strong vibration from touch panel 22 in the touching operation. Accordingly, the uncomfortable feeling will be reduced.

On the contrary, display device 1A may be configured such that operator's fingers receive strong vibration from touch panel 22 in the touching operation, i.e., an operator receives a sense of click. In this case, voice signal producing device 44 operates to produce a vibration signal. The vibration is conveyed from touch panel 22 and received by an operator. A frequency of the vibration is preferably lower than that of audible sound. In short, by emphasizing or attenuating the vibration, display device 1A can change a response to the instruction from an operator.

As mentioned above, conference system 2 using display device 1A and display unit 1 can provide a lively voice corresponding to an image associated with attendees located remotely. Further, display devices 1A located remotely from each other can share the same functions in real time over their entire display surfaces. This makes the conference system more convenient.

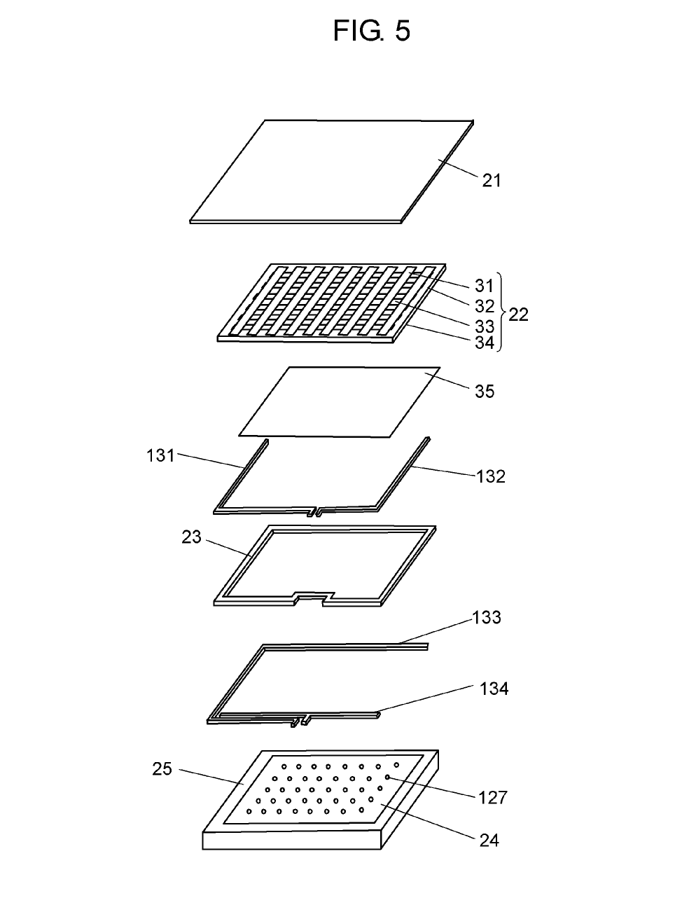

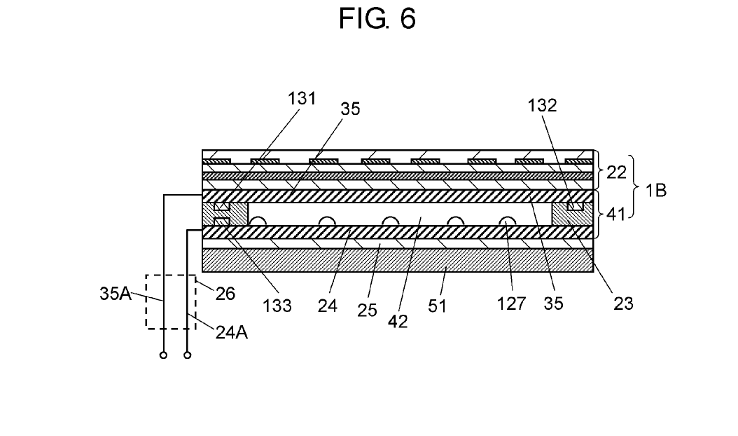

Furthermore, as shown in FIGS. 5 and 6, display device 1A is allowed to have metal electrodes 131, 132 that are disposed along a short side of first conductive layer 35 and interposed between first conductive layer 35 and second conductive layer 24. Display device 1A is also allowed to have metal electrodes 133, 134 that are disposed along a long side of second conductive layer 24 and interposed between first conductive layer 35 and second conductive layer 24.

As a result, first conductive layer 35 and second conductive layer 24 constitute a second touch panel of a resistive film type, in addition to touch panel 22 as a first touch panel which is disposed on the operation surface side.

In this case, first conductive layer 35 and second conductive layer 24 are needed to be capable of contacting with each other. Accordingly, dielectric 42 is formed of the air.

Metal electrodes 131, 132 are disposed along the short side of first conductive layer 35. Metal electrodes 131, 132 are connected to wiring 35A in cable 26. Metal electrodes 133, 134 are disposed along the long side of second conductive layer 24. Metal electrodes 133, 134 are connected to wiring 24A in cable 26. Metal electrodes 131, 132, 133, 134 are preferably made of a metal material such as copper and silver. To prevent the attenuation of signals passing through metal electrodes 131, 132, 133, 134, high conductive metal is more preferable.

On the upper surface of second conductive layer 24, hemispherical dot spacers 127 are disposed at a predetermined interval in a matrix manner. Dot spacers 127 are provided to avoid first conductive layer 35 and second conductive layer 24 from contacting with each other when no operators press the operation surface. Dot spacers 127 may also be formed of a dielectric.

In addition to touch panel 22 which is located on the operation surface side, a resistive touch panel whose electrodes are constituted by first conductive layer 35 and second conductive layer 24 is provided. Thus, the resistive touch panel can sense a kind of touch operation that a capacitive touch panel is difficult to sense. For instance, an operator often carries out a touch operation with his or her fingers covered with gloves and the like, or operates a touch panel by using an instruction stick. Even in that case, display device 1A can sense the operation correctly. In other words, display device 1A is usable in both cases: a fine operation with fingers and a coarse operation by using an instruction stick, which causes a large force.

First conductive layer 35 and second conductive layer 24 are necessary to contact with each other partially and electrically. Thus, first conductive layer 35 on the operation surface side is especially needed to deform sufficiently.

Further, first conductive layer 35 and second conductive layer 24 are inhibited to operate as a speaker when operating as the resistive touch panel. Accordingly, a function selecting part (not shown) for selecting either one of functions by an operator is preferably provided. Alternatively, it is preferred to provide a control function part (not shown) for selecting either one of functions automatically based on an operation from an operator or external signals.

Furthermore, first conductive layer 35 and second conductive layer 24 may operate as the resistive touch panel while operating as a vibration part of electrostatic speaker 41. In this case, touch panel 22 is not provided in display device 1A. Therefore, in the case where display device 1A is used outdoors as a large scaled display and a fine operation with fingers is not necessary, display device 1A becomes more convenient.

In the above description, display device 1A includes touch panel 22, electrostatic speaker 41, and display panel 51. Herein, touch panel 22 and electrostatic speaker 41 constitute input device 1B. If no display is needed, display panel 51 can be eliminated. Touch panel 22 and electrostatic speaker 41 are used as input device 1B. Also in this case, touch panel 22 can make a voice sound and/or vibrate in response to operator's pressing operation of touch panel 22.

### INDUSTRIAL APPLICABILITY

The display device in accordance with the present disclosure can emit a voice from the entire touch panel rather than a deviated portion of the touch panel, and produce a lively voice corresponding to an image. Thus, the display device is useful in various kinds of electronic equipment.

### REFERENCE MARKS IN THE DRAWINGS

1 display unit
1A display device
2 conference system
3 telecommunications device
4 camera
5 microphone
6 first segment
7 second segment
8 third segment
21 cover lens
22 touch panel
23 spacer
23A square hole
24 second conductive layer
24A, 31A, 33A, 35A, 51A, 51B wiring
25 vibration substrate
26 cable
31 first electrode
32 first substrate
33 second electrode
34 second substrate
35 first conductive layer
41 electrostatic speaker
42 dielectric
43 voice signal input terminal
44 voice signal producing device
51 display panel
52 image signal input terminal
53 image signal producing device
101 touch panel controller
101A touch panel control terminal
127 dot spacer
131, 132, 133, 134 metal electrode

1. A display device comprising:
a touch panel having an operation surface;
an electrostatic speaker provided on an opposite side of the operation surface and having a first conductive layer, a second conductive layer facing the first conductive layer, and a dielectric interposed between the first conductive layer and the second conductive layer; and
a display panel provided on an opposite side of the electrostatic speaker with respect to the touch panel,
wherein the touch panel is a capacitive touch panel; and
the first conductive layer and second conductive layer are contactable with each other and constitute a resistive touch panel.

2. The display device according to claim 1, further comprising a vibration substrate disposed between the electrostatic speaker and the display panel.

3-4. (canceled)

5. A display unit comprising:
the display device according to claim 1;
a voice signal producing device connected to the first conductive layer and the second conductive layer; and
an image signal producing device connected to the display panel.

6. A conference system comprising:
the display unit according to claim 5; and
a telecommunications device connected to the voice signal producing device and the image signal producing device.
